(19) United States
(12) Patent Application Publication
(10) Pub. No.: US 2016/0358129 A1
(43) Pub. Date: Dec. 8, 2016

(54) METHODS AND SYSTEMS FOR FLEET MANAGEMENT

(71) Applicant: MTCT Group LLC, Spring, TX (US)

(72) Inventors: Mark Adam Walton, Spring, TX (US); Eugene Thomas Johnson, Spring, TX (US)

(21) Appl. No.: 15/237,732

(22) Filed: Aug. 16, 2016

Related U.S. Application Data
(63) Continuation-in-part of application No. 15/052,645, filed on Feb. 24, 2016.
Application No. 15/052,645 is a continuation of application No. 14/657,231, filed on Mar. 13, 2015, now Pat. No. 9,305,407.
(60) Provisional application No. 62/109,029, filed on Jan. 28, 2015.

(51) Int. Cl. G06Q 10/00; G07C 5/00; G07C 5/08; G06Q 40/08; G08G 1/00

(52) U.S. Cl. CPC G06Q 10/20; G06Q 40/08; G08G 1/20; G07C 5/0841; G07C 5/008

(57) ABSTRACT

Methods and systems are disclosed for analyzing, predicting, and processing an accident. One embodiment for analyzing includes identifying a type of the accident based on evidence, wherein the identifying comprises by an accident tracker app loaded on a device and optionally a fleet management system, wherein the accident tracker app and the fleet management system are in network connection and associated with logic, processors, and data storage. The methods and systems may include enabling logic for assessing, by the accident tracker app, the fleet management system, or combination thereof, severity of the accident based on the evidence related to the accident. Further, the methods and systems may include enabling logic for comparing, by the accident tracker app, the fleet management system, or combination thereof, the evidence for the accident, and for determining, by the accident tracker app, the fleet management system, or combination thereof, a disposition for the accident.

### CROSS-REFERENCE TO RELATED APPLICATIONS

The current application is a continuation-in-part patent application, which claims priority to a co-pending patent application having Ser. No. 15/052,645, filed on Feb. 24, 2016, and titled, “Method for Fleet Management,” which is a continuation application, which claims priority to: (1) U.S. non-provisional patent application having Ser. No. 14/657,231, filed Mar. 13, 2015, titled “Method for Fleet Management,” and now U.S. Pat. No. 9,305,407; and (2) U.S. provisional patent application having Ser. No. 62/109,029, filed Jan. 28, 2015, titled “Fleet Management System,” and now abandoned. By this reference, each of the foregoing references is incorporated herein in their entirety.

### FIELD OF DISCLOSURE

This disclosure generally relates methods and systems for fleet management of one or more vehicles, planes, maritime craft, incidents, and so forth. More particularly, this disclosure relates, for example, to methods and structures configured for creating, tracking, monitoring, identifying, calculating, predicting, and generating data for management of accidents.

### BACKGROUND

Accidents are commonplace and costly, especially when viewed as a group of related items, such as a fleet of vehicles. Streamlining methods and systems for analyzing type and cause of accidents, as well as providing remedy therefor and predicting them, will allow companies to better understand the root cause, and, thereby, permit implementation of procedures for corrective action aimed at mitigating accidents and hasten return of assets to operating condition. These are some of the goals of the disclosed methods and systems herein.

### SUMMARY OF THE INVENTION

In one embodiment, there is a system for analyzing an accident, the system may include an accident tracker app loaded on a device, a fleet management system, or combination thereof is in network communication and associated with logic, memory, processors, and data storage, wherein the accident tracker app, the fleet management system, or combination thereof are configured to identify, based on evidence, a type of the accident. Further, the system may include further logic, reduced to hardware and/or software, associated with the accident tracker app loaded on a device, a fleet management system, or combination thereof configured to assess, based on the evidence related to the accident, severity of the accident, and compare the evidence for the accident. Further still, the system may include additional enabling logic configured to determine a disposition for the accident, which may include determining a score of the driver or the driver's company in order to determine the disposition(s).

In another example embodiment, disclosed is a system, which may include an accident tracker app loaded on a device, a fleet management system, or combination thereof is in network communication and associated with logic, memory, processors, and data storage, wherein the accident tracker app, the fleet management system, or combination thereof are configured to identify, based on evidence, a type of the accident. Further, the system may include further logic, reduced to hardware and/or software, associated with the accident tracker app loaded on a device, a fleet management system, or combination thereof configured to gather the evidence related to the accident from the one or more resources, and to determine, based on the evidence, the probability of the accident, wherein the evidence comprises weather conditions, mechanical fitness of type of fleet operated, time and day, traffic conditions, traffic patterns, severity, cost, downtime, the type, associated person(s), driving records, driving score of any driver in the accident, data, measurements, road conditions, microclimates, probability of right turns versus left turns, probability of direction of travel, frequency of direction of driving into the sun known variables, deduced variables, calculated data or combinations thereof.

In another example embodiment, disclosed is a system for processing data, wherein the system may include an accident tracker app loaded on a device, a fleet management system, or combination thereof is in network communication and associated with logic, memory, processors, and data storage, wherein the accident tracker app, the fleet management system, or combination thereof is configured to read data, wherein the data comprises documents, files, data points, or other information. Further, the system may include further logic, reduced to hardware and/or software, associated with the accident tracker app loaded on a device, a fleet management system, or combination thereof configured to gather the evidence related to the accident from the one or more resources, and to gather, based on identified subject matter, at least a portion of the data, wherein the identified subject matter comprises a person, entity, vehicle, location, event, words, or combinations thereof within a period, and to route at least a portion of the at least a portion of the data to a destination.

Turning to another aspect, also disclosed is an example embodiment of a method for analyzing an accident, wherein the method may include identifying, based on evidence, a type of the accident, wherein the identifying comprises by an accident tracker app loaded on a device and optionally a fleet management system, wherein the accident tracker app and the fleet management system are in network connection and associated with logic, memory, processors, and data storage. Further, the method may include assessing, by the accident tracker app, the fleet management system, or combination thereof, severity of the accident based on the evidence related to the accident. Further still, the method may include comparing, by the accident tracker app, the fleet management system, or combination thereof, the evidence for the accident. Yet further, the method may include determining, by the accident tracker app, the fleet management system, or combination thereof, a disposition for the accident.

In addition, disclosure is an example embodiment of a method for predicting a probability of an accident, wherein the method may include identifying, based on evidence, a type of the accident, by an accident tracker app, a fleet management system, or a combination thereof, associated with logic, processors, memory, sensors and data storage. Further, the method may include gathering, by the accident tracker app, the fleet management system, or combination thereof, the evidence related to the accident from one or more resources in network communication with the fleet management system. Further still, the method may include determining, by the accident tracker app, the fleet management system, or combination thereof, the probability of the accident based on the evidence comprising weather conditions, mechanical fitness of type of fleet operated, time and day, traffic conditions, traffic patterns, severity, cost, downtime, the type, associated person(s), driving records, driving score of any driver in the accident, data, measurements, road conditions, microclimates, probability of right turns versus left turns, probability of direction of travel, frequency of direction of driving into the sun known variables, deduced variables, calculated data or combinations thereof obtained from the one or more resources, sources, or combinations thereof in network communication.

In another example embodiment, disclosed is a method for processing data, wherein the method may include reading, by a fleet management system, a device having an accident tracker app, or combination thereof, the data, wherein the data comprises documents, files, data points, other information, wherein the fleet management system, the at least one device having an accident tracker app, or the combination thereof, is in network connection and associated with logic, memory, processors, and data storage. Further, the method may include gathering, by the fleet management system, the device having an accident tracker app, or the combination thereof, at least a portion of the data based on identified subject matter, wherein the identified subject matter comprises a person, entity, vehicle, location, event, words, or combinations thereof within a period. Further still, the method may include routing, subsequent to the gathering, a least a portion of the at least a portion of the data to a destination.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 depicts an example computer optionally found in the disclosed devices and systems for use or in operation with the methods and systems also disclosed herein.

FIG. 2 depicts an example embodiment of the environment and resources associated with the disclosed accident tracker app, device and fleet management system (a.k.a. “management system”) in combination with the disclosed methods and systems.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

In addition, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away from the earth's surface, and “below,” “lower,” “downward,” “bottom,” and similar terms refer to a direction toward the earth's surface, but is meant for illustrative purposes only, and the terms are not meant to limit the disclosure.

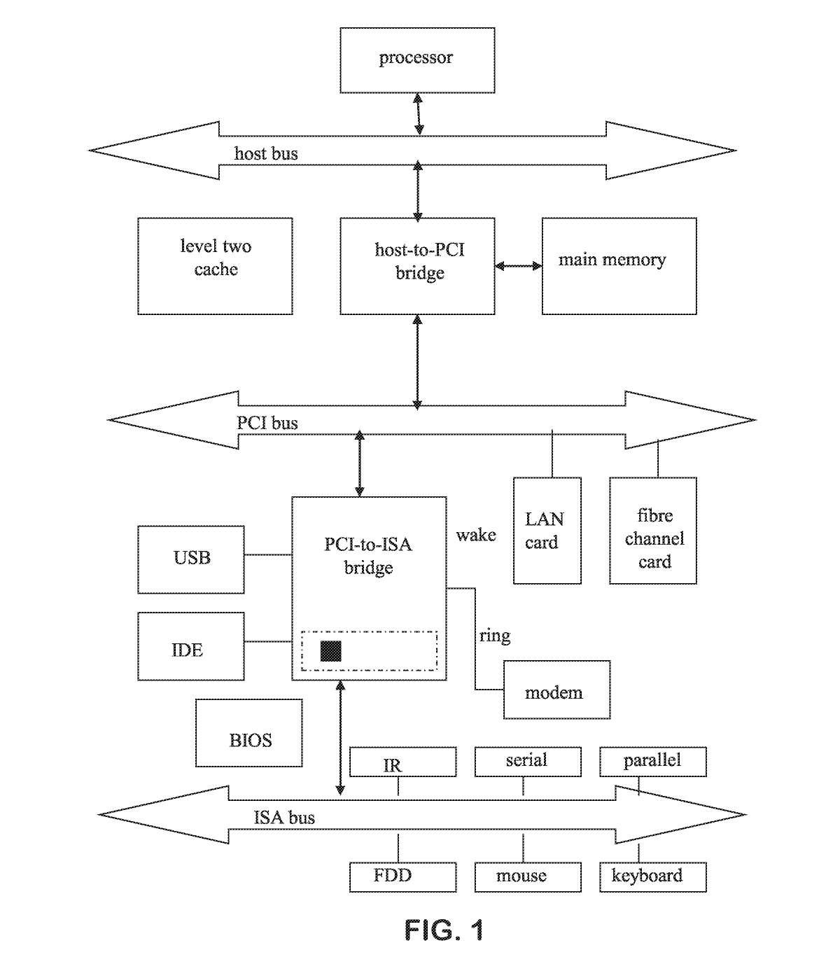

Generally disclosed are methods and structures configured for analyzing and predicting probability of an accident, regardless of the type, e.g., personal, bodily injury, property, vehicular, boat-like, aviatorial, mechanical, chemical, electrical, hydraulic, pneumatic, other types of accidents, or combinations thereof. To effectuate such analyzing and predicting, enabling logic exists, for example, for identifying, gathering, comparing, determining, calculating, assessing, assigning, alerting, selecting, generating, reporting, transmitting, sending, and receiving data among networked entities, people and resources that may involve fleet management of one or more vehicles, planes, trains, maritime craft, farm equipment, cargo, parcels, incidents, people, and so forth. More specifically, and turning now to FIG. 1, disclosed is an example schematic of logic, reduced to software and/or hardware, in wired or wireless connection for performing and executing the computer-based instructions to enable the disclosed methods and systems herein. On the client-side of FIG. 1 is an application or “app” installed, downloadable or otherwise, onto a client device, such as a desktop computer, laptop, personal digital assistant, mobile phone, and so forth. The client device may include at least one operating system, logic, processor associated with memory, which may or may not be removable, volatile, and local. Communicatively coupled to the client device, such as via wireless network communication, are associated resources, wherein each resource may reside in one or more remote or distant locations with respect to the client device and/or other resource(s). For ease of communication, these resources will be said to be on the “server-side.” Such resources may be cloud-based or traditional, and include, for instance, processors, drivers, servers, databases, routers, memory, operating systems, application program interfaces, servlets, other applications, printers, and other hardware and/or software.

An exemplary computer system, such as that within the client device and/or on the server-side, for use with the disclosed methods and systems may include a processor, which is coupled to host bus coupled to cache memory. A host-to-personal computer interface (PCI) bridge is coupled to main memory, which includes cache memory and main memory control functions, and provides bus control to handle transfers among the PCI bus, processor, cache, main memory, and host bus. A PCI bus provides a standard interface for connecting peripherals, such as a local area network card. A PCI-to-industry standard architecture (ISA) bridge functions as a PCI target on the PCI bus to manage transfers between PCI bus and ISA bus, universal serial bus functionality, integrated drive electronics device functionality, power management functionality, a real-time clock, direct memory access control, interrupt support, and system management bus support. Peripheral devices and input/output devices can be attached to various interfaces, e.g., parallel interface, serial interface, infrared interface, keyboard interface, mouse interface, fixed disk, and removable storage device, coupled to ISA bus.

Basic input/output system is coupled to the ISA bus, and incorporates the necessary processor executable code for a variety of low-level system functions and system boot functions. BIOS can be stored in any computer readable medium, including magnetic storage media, optical storage media, flash memory, random access memory, read only memory, and communications media conveying signals encoding the instructions, e.g., signals from a network. In order to attach the computer system to another computer system to copy files over a network, a local area network card is coupled to PCI bus and to PCI-to-ISA bridge. Similarly, to connect the computer system to an ISP to connect to the Internet using a telephone line connection, a modem is connected to a serial port and the PCI-to-ISA Bridge.

While the foregoing computer systems are capable of executing the disclosure described herein, these computer systems are simply examples of computer systems and user computer systems. Those skilled in the art will appreciate that many other computer system designs are capable of performing the disclosure described herein.

Another embodiment of the disclosure may be implemented as a program product for use within a device such as, for example, those above-described methods and systems. The program(s) of the program product defines functions of the embodiments (including the methods described herein) and can be contained on a variety of media including but not limited to: (i) information permanently stored on non-volatile storage-type accessible media, e.g., write and readable as well as read-only memory devices within a computer such as read-only memory, flash memory, CD-ROM disks readable by a CD-ROM drive; (ii) alterable information stored on writable storage-type accessible media, e.g., readable floppy disks within a diskette drive or hard-disk drive; and (iii) information conveyed to a computer through a network. The latter embodiment specifically includes information downloaded onto either permanent or even sheer momentary storage-type accessible media from the World Wide Web, an internet, and/or other networks, such as those known, discussed and/or explicitly referred to herein. Such data-bearing media, when carrying computer-readable instructions that direct the functions of the present disclosure, represent embodiments of the present disclosure.

In general, the routines executed to implement the embodiments of this disclosure, may be part of an operating system or a specific application, component, program, module, object, or sequence of instructions. The computer program of this disclosure typically comprises a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of this disclosure. However, it should be appreciated that any particular program nomenclature that follows is used merely for convenience, and, thus, this disclosure should not be limited to use solely in any specific application identified and/or implied by such nomenclature.

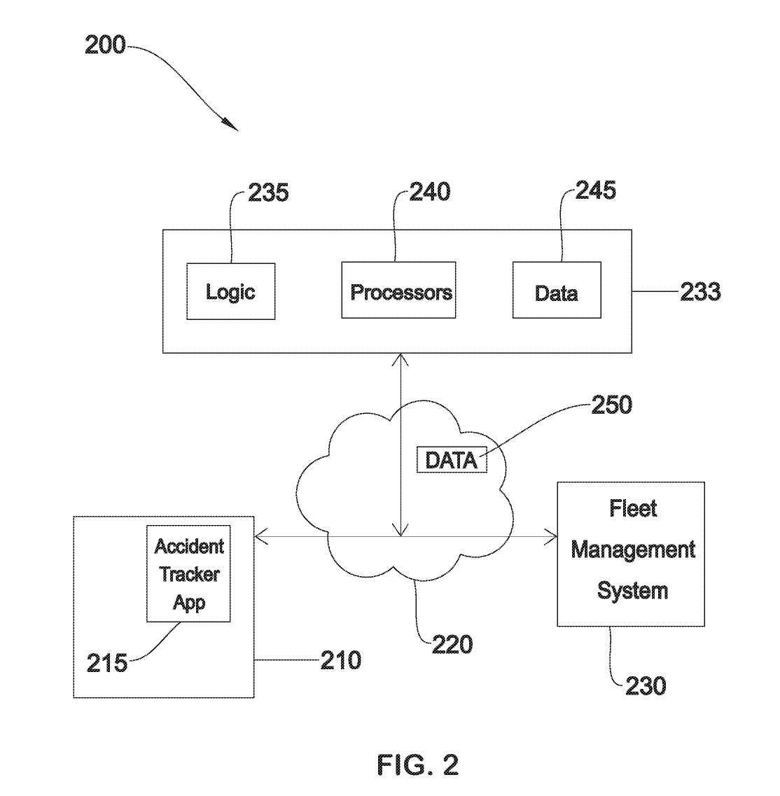

Turning now to FIG. 2, this figure depicts an example embodiment of a system 200 providing for the following disclosed methods, wherein the system 200 and methods include a client device 210, such as one having an installed accident tracker app 215, for an individual, such as a driver, accident victim, system administrator, employer, or any other person, to use in relation to analyzing and predicting any accident type, e.g., personal, bodily injury, property vehicular, boat-like, aviatorial, mechanical, chemical, electrical, hydraulic, pneumatic, other type, or combinations thereof. The device 210, itself, for example, may include a mobile phone, a smart phone, a personal digital assistant, a computer, a laptop, a tablet, a watch, a wearable device, an implantable device, other device, or combinations thereof. In various embodiments, the accident tracker app 215 may be remote or local to the device 210 and associated with the device 210 through installation, download or upload. Furthermore, the accident tracker app 215 may work in tandem with the device's 210 operating system. However, if device's 210 operating system does not integrate with the device 210, then enabling logic, such as logic 235, which is reduced to software and/or hardware, provides cross-platform logic. For example, if the device 210 is a Windows® phone using Windows-based operating system, and the accident tracker app 215 or any of its logical routines are for iPhones® instead of Windows® phones, then logic 235 may enable such iPhone accident tracker app 215 with cross-platform logic, such as by Xamarin® or other vendors, in order to operate on a Windows® phone.

The methods and systems of this disclosure may also include a fleet management system 230, which co-pending, non-provisional, U.S. patent application Ser. No. 15/052,645 discloses, the entirety of which is incorporated herein by this reference. With continued reference to FIG. 2, the fleet management system 230 may communicate via network 220, whether in wired and/or wireless connection, with the accident tracker app 215 and one or more of a host of other resources, networks, entities, people, devices, and combinations thereof. For example, in the system 200, enabling logic 235, processors 240, and data storage 245 are depicted to be in network 220 communication with the device's 210 accident tracker 215 and the fleet management system 230 in order to permit the exchange of data 250 for effectuating analyzing and predicting accidents. In various embodiments, the enabling logic 235, processors 240, and data storage 245 may be local and/or remote to each of the device 210, accident tracker 215 and fleet management system 230, and such 235, 240, 245 may be shared or not shared, wherein the not shared embodiment means that the device 210, accident tracker 215 and fleet management system 230 each have at least a portion of the enabling logic, processors, and data storage that belongs only to the device 210, accident tracker 215 and/or fleet management system 230. Viewed from another perspective, remote resources, e.g., logic 235, processors 240 (e.g., administrator processors, dispatcher processors, vehicle management processors, accident tracker processors etc.), data storage 245, drivers, servers, databases, routers, memory, operating systems, application program interfaces, servlets, other applications, printers, and other hardware and/or software may be on servers and/or cloud-based, e.g., Microsoft® Azure®. In a client-side view, the resources are local, e.g., installed on and/or in singular communication with, the device 210, accident tracker 215 or fleet management system 230.

Now, discussion of what the enabling logic 235 further facilitates ensues. Alongside identifying the type of accident based on the evidence is assessing its severity based on the evidence, whereby both steps occur by enabling logic 235, reduced to hardware and/or software, associated with the device's 210 accident tracker app 215 and optionally the fleet management system 230, which may also be called a management system when the accident type does not involve any type of vehicle, but, instead, relates to personal injury, property injuries, cargo, property damage, etc. In order to identify the accident type and assess accident severity, enabling logic 235 gathers, evaluates, and compares evidence, which may include reading gauges, sensors, airbag deployment, instrumentation, vital signs, orientation, location, impact, velocity, speed, acceleration, deceleration, temperature, global positioning system data, location, impact forces and angles, g-force values, user input, databases, stored data, other readable measurement such as distance between axels or miles driven, e.g., including enabling logic for determining miles per jurisdiction, such as by further enabling logic that geo-stamps time and location of undertaken activities, e.g., refueling, going to a drug glass, etc., or combinations thereof. From a network perspective, the enabling logic for gathering may occur in any of a variety of ways, such as over the internet, peer-to-peer, IoT, wired or wirelessly, through the CAN Bus of the truck, and so forth. Gathering of the evidence may be from any source, e.g., any company, administrative, proprietary, public, governmental resource in network 220 connection with the with the device's 210 accident tracker 215, fleet management system 230, or both; in other example embodiments, such source may be in one or more non-depicted network connections with the device's 210 accident tracker 215, fleet management system 230, or both. The gathering, itself, may be by pushing, pulling, search in place or pull on demand data 250, which is for communicating, i.e., sending and receiving, to the device 210, the device's 210 loaded accident tracker app 215, and/or the fleet management system 230. See, e.g., https://www.infoq.com/news/2015/09/Push-Pull-Search (visited Aug. 4, 2016), incorporated herein by this reference. Receiving of the evidence or data 250 may be from a person, third party system, another device or combination thereof that is read, input or extracted, automatically or manually.

Additional enabling logic 235, reduced to hardware and/or software, permits the device's 210 accident tracker app 215 and/or fleet management system 230 to further assess the severity of a type of accident by calculating anticipated costs, downtime, other severity assessments or combinations thereof. Before assessing the severity, however, the disclosed systems 200 and methods include gathering evidence, which may include taking photographs with enabling logic 235 within the device 210 and/or accident tracker app 215. The system 200 may transmit 220 all the evidence, e.g., photographs, to the fleet management system 230 for ultimate routing and/or use by mechanics, attorneys, insurance agencies, etc., in communication 220 therewith 230. In other example embodiments, the fleet management system 230 has enabling logic 235 that culls the evidence and selectively routes or permits access to only the portion of evidence that a particular person/entity should view. For example, a hospital may see evidence only pertaining to sustained personal injuries and vital signs, whereas an insurance company may see evidence only pertaining to mechanic's repair bills and sustained automobile damage, location, weather conditions and vehicle orientation. In addition to transmitting 220 and/or permitting access to the correct photographs for an accident, enabling logic 235 within the device 210 and/or accident tracker app 215 may record the latitude and longitude as well as time of day, a capture that may have benefit for a tow truck and other first responders so that they may find the accident location more easily. When the information is routed to the right location on the fleet management system 230 and data storage 245 associated therewith 230 within the operation of the business, the right data is accessible to the right people at the right time, and, thereby, garnering a streamlined process, which improves efficiencies and profitability while protecting privacy of the entity, customer or a driver.

During the accident investigation process, a user may indicate involvement in an accident by using a device 210 either loaded with or in communication with one or more servers, cloud-based resources, etc. loaded with the accident tracker app 215, which communicates the indication over a network 220 to the fleet management system 230 and its 230 resources 233. If the user calls 911 from the device 210, then the fleet management system 230 may interpret such as indicative of a more advanced degree of damage or injury, i.e., severity, whereby the fleet manager of the fleet management system 230 may be notified 250 that an injury may be present and that the fleet manager should escalate the matter. Severity is also indicated by transmitted 220 receipt by the fleet management system 230 and its 230 resources 233 of data 250, e.g., sensed measurements, received by the device 210 loaded with the accident tracker app 215, and examples include as speed as it relates to a g-force event, accelerometer data indicating an overturned vehicle, sound, airbag deployment, change in speed among other impact data, and so forth. Severity may also be measured by the inclusion of multiple other drivers or the simple existence of another driver.

Sensed measurements and other data received by the device 210 loaded with the accident tracker app 215 may be assessed and further routed to the right place on the servers, computers and devices in network or wired communication with the fleet management system 230 and its 230 resources 233. For example, the data 250 may present on a display associated with the fleet management system 230, whereby a dispatcher or other person may make decisions based on incoming data 250 or just want to stay abreast of developments. Received and/or stored data 250 associated with the fleet management system 230 and its 230 resources 233 may be further routed and/or accessed by anyone with permission, such as an attorney, an insurance adjuster for claim handling, a government official based on jurisdictional requirements, and so forth. Enabling logic 235 permits the system 200 to parse and route data 250 quickly and appropriately, thereby allowing for increased efficiency in handling and resolving accidents.

The prompt post-accident processing and routing of the data 250 is crucial to the outcome of the injury or loss. The evidence, i.e., manifested as data 250, from the accident scene and post-accident investigation is gathered and assessed quickly by the networked 220 device 210 having the accident tracker app 215 and fleet management system 230 in concert with resources 233 and/or additional resources (e.g., routers, printers, keyboards, monitors, other servers, processers, etc.) connected by wire or other network(s), a device 210 user's (e.g., driver's) input and received data 250 from sensors to assure that the correct data or portion thereof 250 is routed to the correct user, e.g., doctor, mechanic, hospital, police officer, etc. For example, a driver may get into an accident and a processor and server may determine if the driver should or must be drug tested based on severity, the type of equipment being operated, or any number of other reasons, all of which is data 250 accessible to the disclosed methods and systems 200. The network 220 may identify the correct facility to send the driver based on location, contract terms, appointment availability, severity of accident, accessibility, among other criteria, all of which is data 250 accessible to the disclosed methods and systems 200. Say that the system 200 communicates 250 to the driver on the device 210 having the accident tracker app 215 that the closest recommended or mandated facility that a driver is to attend is one mile away, but that facility is not in a group of pre-selected service providers, e.g., out-of-network, shoddy work, road construction en route, etc., and the second closest is 1.5 miles away and is preferred for any default or configured reason, e.g., in-network, costs, quality of work, etc.; accordingly, enabling logic 235 for the disclosed methods and systems 200 would send the driver to the second closest location. As part and parcel with the chosen facility, further enabling logic 235 for the disclosed methods and systems 200 would route, automatically or manually, any required data 250 gathered as evidence to the disclosed methods' and systems' 200 selected service provider's computer to schedule, automatically or manually, the appointment or a reminder. As this happens, other data 250 is parsed and sent to the driver, being notified by his device 210 while management is able to identify the disposition by looking into his system 200. The routing of the correct yet limited information to the right people is crucial during this very short period of time post-accident. In this particular case, the proper routing, storage and presentation of data 250 may be done instantaneously or nearly instantaneously after the accident, and, thereby, allow for improved and more reliable drug testing results because the disclosed methods and systems reduce the time that the driver may attempt to or affect the accuracy of the drug testing results.

As another example of expeditious routing, whether automatically or manually, during the post-accident process, when an accident occurs, the system 200 may automatically or manually gather or cause to be gathered (e.g., by commands appearing on the device's 210 display enabled by the accident tracker app 215 loaded thereon) certain information, at least a portion of the evidence, i.e., data 250, or combination thereof, from the accident scene, wherein such data may include photographs of all four corners of the vehicle, broad photographs of the accident scene, and recorded statements of the driver and any witness(es). Based on severity of the accident, as measured by received data 250 by the fleet management system 230, only a portion of the received data may end up being sent to an insurer, in network communication with the fleet management system 230, for filing an insurance claim or to create an accident summary report. In a severe accident, the photographs, time, date, and location may be sent 220 to the fleet management system 230, which may be configured to send the same or different portions of the received data 250 to another insurer, attorney, risk manager, safety director, and/or any other person or combination thereof. What is ultimately sent to or received by a third party may depend on default or pre-configured roles and permissions for people interacting with the system 200, such as with ELD matters discussed later in this disclosure. By way of further example, such interacting may include a driver utilizing the system 200 to go into personal conveyance and/or local radius modes. Further still, such interacting with the system 200 may include mechanic, administrator, fleet manager permissions that are configured and configurable for allowing the user to view only the information a permitted role is are allowed to see.

After receipt of data 250, the disclosed methods and systems 200 may access, e.g., pull and/or push, appropriate records 250 from its resources 233 and/or external resources in order to determine the cost of operating a truck, the revenue generated, should the load be re-routed and where based on estimated time for the repair, potential for lost down-time, and so forth. The disclosed methods and systems 200 possess enabling logic 235 to estimate lost down-time costs by taking the length of time to repair a vehicle and multiplying by the cost of down-time per day plus the total cost of repair. If lost down-time cost exceeds the cost of a new truck, then the system 200 would make the determination that the truck is totaled and a new truck should be purchased instead of repairing the unit.

The disclosed methods' and systems' 200 enabling logic 235 may also use this data 250 to estimate the total cost and compare a service provider's ability to repair a vehicle in a timely manner relative to the cost of repair, proximity, downtime, among other relevant considerations. In this case, the system 200 may estimate to business days for the repair time, based on sensed and recorded data as well as service provider input and other outside and internal data 250 received by the fleet management system 230. The fleet management system 230 may then use the same criteria and apply the inputs from the next service provider and repeat this process for all qualified service providers. At that point, the methods and system 200 may determine which location to send the truck for repair. The fleet management system's 230 enabling logic 235 may then determine which information is relevant to that particular third-party service provider. For example, the repair shop does not need the date, time, and location of the accident unless the repair shop also provides the wrecker service. The repair shop may need the year, make, model and VIN of the truck in the accident, however, and the system 200 may provide such portion of data 250 to the repair shop. Assessing what to send to whom may be automated and/or is optionally presented to the manager for review, edit, rejection and/or approval, all of which is enabled by logic 235 associated with the disclosed method's and system's resources 233, which also include non-depicted routers, printers, keyboards, and other hardware and peripherals.

Data 220 from accident scenes may be pulled or pushed from sensors and recorders located in on-board electronics or may be sent directly from the sensors and recorders to the device 210 having the accident tracker app 215, fleet management system 230 or combination thereof for processing by the disclosed methods and systems 200 and/or people using the disclosed methods and systems 200. Additionally and alternatively, the sensors' and recorders' data may be assessed on-board prior to being sent or received by the accident tracker app 215, fleet management system 230 or combination thereof for further processing. The transmitted 220 data 250 may be used to efficiently create a work-flow for the vehicle repair or treatment for an injured worker, vehicle, boat, and so forth. With this data 250, limited correct information may be sent on further to a third-party service provider(s) for repair of the vehicle, other equipment, or person. Thereafter, the person or vehicle being repaired may be tracked based on the network 220 or a separate network or wired connection with the third-party service provider(s). Until now, there was no way to automatically schedule a repair and determine which facility to send a vehicle for repair based on proximity, severity, predictive collision, and so forth. As an example, the system 200 may assess the injury based on transmitted 220 data including, for example, speed and/or velocity of the vehicle, deceleration at the point of impact, airbag deployment, user input, weather conditions, and so forth. If the accident is severe, then certain information may be provided to first responders by the device having the smart tracker app 215 and/or the fleet management system 230. Some of the information that might be provided is blood type, health history, emergency contact information, insurance information, employment history or even driving history. Based on the need to know the information, an EMT may not need to know the VIN of the vehicle but a police officer would. The disclosed methods and systems 200 may determine who may be in receipt of what data on a case-by-case basis.

During the process of assessing damage in an accident, the system 200 may use its resources 233 and/or external resources in communication therewith, to determine how to handle any on-board cargo. For example, if a truck crashed, its cargo may need sorting before being delivered; else, the system's 200 enabling logic for performing a cost analysis may determine that scrapping the cargo is cheaper and preferred as compared to sorting and scrapping. Depending on the severity of the accident, the data 250 from, for instance, the sensors, user input, time of day, weather, etc. may be sent to and stored in the fleet management system 233 and/or its associated resources 233 or other resources external to the system 200. In addition, the data 200 may be reviewed and compared to the customer's needs, such as delivery deadline, refrigeration, oversize load permits, hazardous materials permits, and so forth. By the system 200 enabling such an immediate assessment, this may allow for the system 200 to determine the next available truck to take delivery of the cargo to the customer with, prior to arrival, both a new estimated time of arrival and a damage estimate. This efficiency reduces down-time, back-charges and industrial disruption, among other things. Because this data 250 is parsed and delivered quickly by the system 200 to proper third parties systems and people, the disclosed methods and systems provide improve efficiencies and profitability across multiple business platforms. As an example, suppose a truck's cargo is beef heading to Miami, but the truck crashes in Orlando. Since Orlando is a three-hour drive to Miami, the system 200 determines whether any other trucks are nearby that have capacity for refrigerating beef requiring delivery to Miami. One way that the system's enabling logic analyzes the dilemma presented in the preceding sentence is to use GPS data, loading records, dispatch records, and so forth. If the system 200 identifies a truck as being in Ocala, which is about 1.5 hours north of Orlando, and further identifies that said truck has capacity, then this Ocala truck may be the right fit. The system 200 may then determine what kind of equipment the truck has and if it can transport the beef to Miami. The truck might also have additional sensors, such as iBeacon™ or NFC™ technology, used to confirm accuracy of information received by the fleet management system 230. Because the fleet management system 230 determines that this Ocala truck is available and can carry the beef cargo, then the cargo is transferred to this truck and the recipient, in network or wired communication with the fleet management system 230, is automatically notified by the fleet management system 230 that the cargo may be arriving and may be provided with an estimated time of arrival. Furthermore, the methods and systems 200 may calculate the estimated time of arrival and deliver that to the customer, dispatcher, manager or other stakeholder as directed or requested by the fleet management system 230 to the same or another device 210 having an accident tracker app 215. The estimated time of arrival may be calculated, for example, based on one or more of the following variables: road miles, traffic jams, weather, equipment breakdowns, availability of mobile forklifts or other equipment, and other variable(s). In the Ocala-Orlando-Miami example, if the system 200 determines that it may take the truck 1.5 hours to arrive in Orlando from Ocala, the forklift 2 hours to arrive, and another 30 minutes to move the cargo, then the system 200 may estimate the time of arrival in Miami at the sum of the 2 hours travel for the forklift, 30 minutes to move the cargo, and the additional 3 hours to drive from Orlando to Miami. The fleet management system 230 and its resources 233 may email, text, call or otherwise communicate with a device 210, optionally having an accident tracker app 215 loaded thereon, with the estimated time of arrival to the recipient or other stakeholder. The system 200 and its logic 235 may also be configured to determine the damage sustained by the cargo and estimate the costs, impact, remediation needs, or other information based on factors such as speed at impact, straps breaking, movement, ejection, turnover, leakage, deceleration at impact or by other means and then communicate that to stakeholders or determine another disposition based on value, commodity, location, etc. For example, a tanker carrying milk may be in an accident and the milk may begin to leak. Because the system 200 determines an accident occurred and the milk is leaking, the system 200 may likely determine that scrapping the cargo is the best solution because the system 200 understands that the re-collected milk would be contaminated. In another example embodiment, if the cargo was oil, then the system 200 may know to immediately escalate the accident and begin suggesting or ordering steps for remediation. However, if the cargo is sand for the truck in the accident, then the system 200 may seek on-site repair requests to one or more third parties in network 220 communication with the system 200 in order to patch the truck and deliver the product after the sand is recollected.

As previously discussed, the received 220 data 250, or selected portions thereof, from the device 210 having the accident tracker app 215 may be pushed or pulled to any one or more third parties, including a jurisdictional officer, governmental office, official or other person/entity, such as those having configurable roles and/or permission that permit access to the data 250 or portions thereof. This data 250 may be transmitted by network 220, web services and/or email accessible over one or more networks, memory sticks, Bluetooth, and so forth. The system 200 may include enabling logic, such as in the form of code, to determine what data 250 is required as set forth in jurisdictional requirements. For example, the required information might be the gross vehicle weight, the distance between axles, the status of the vehicle registration, the results of recent repairs, fuel reporting, status of the driver's hours of service, driver license status, medical card status, among any other investigative tool as requested or required by the governmental office or official. Specifically, the system's 200 resources, such as those depicted at resources 233 as well as other any other resources, including storage devices, hand-held devices, computers, servers, sensors, cell phones, etc. may be able to route data 250, and particular portions of such data 250. This efficient delivery of the right data 250 at the right time leads to improved accident investigation processes through efficiency and accuracy. The methods and systems 200 may determine which information would be relevant to a particular officer or government official. For example, one jurisdiction may need to know the distance between axles and the gross vehicle weight of the truck. Based on the GPS location, dispatch records, roadway, imagery, optical character recognition (“OCR”), temperature, elevation or other determining factor, the system's 200 logic 235 may generate and/or send a report having the gross vehicle weight, year, make, model, VIN, driver name, driver eligibility status and commodity. In another jurisdiction or circumstance, the system's 200 logic 235 may determine it 200 only necessary to transmit the year, make, model, VIN and commodity. The system 200 has enabling logic to know which data to send to whom in the different circumstances that it 200 may encounter.

The system's 200 enabling logic 235 in combination with received 220 sensed and/or recorded data 250, processors, and storage is able to determine fault and deliver portion(s) of received 220 data 250 only to the right person(s). When the received data 250 is routed by the system 200, only certain individuals and/or entities may have access to that routed data 250. For example, an attorney may have a need to see the same received data 250 as an insurance adjuster, whereas a mechanic or general administrative professional may not need to see the same data, although some of the received data may overlap. Determining what each person/entity needs or may see certain, received data 250 may depend on such data's 250 use, e.g., data necessary or proper for settlement of an insurance claim may include knowing the speed of travel, the hours of service status of the driver, brake status of the truck, operational condition of the truck, repair history of the truck, inspection history of the truck, documentation of the truck, trailer or driver, weather conditions, topography of the location, and/or other considerations. This data 250 may be evaluated by the system's 200 processor(s) 240 and then the system's 200 enabling logic 235, reduced to hardware and/or software, may route to the correct location/person for storage 245, presentation to a specified user, further external and/or internal processing, or otherwise. This received data 250 or portion thereof may be used to calculate an appropriate claims' settlement value, timeline, estimation, severity and route certain data points to certain people or storage devices and other data points to other people or storage devices in communication with the system 200.

Notably, when data 250 is sent through the system 200, only the data 250 that is required by the third-party recipient is sent. The system 200 is able to determine which portion of its 200 data 250 is the correct data 250 to send based on the parameters set forth by the user, manager, or system 200, itself, based, for example, on roles, permissions, and satisfaction of any security credentials.

After an accident occurs, the system 200, whether instructed by the device 210 at the direction of the accident tracker app 215, the fleet management system communicating 220 therewith 210, 215, or both may record the correct data 250 for transmitting 220 and placing in storage 245 for further use. For example, if the system 200 determines that the accident is a department-of-transportation-recordable event based on the data 250 collected relative to the requirements from the device 210, 215 and/or fleet management system 230, then the system 200 may begin an appropriate post-accident process. Specifically and for example, the system's 200 enabling logic 235 may create a post-accident, training process, or, depending on a given situation, send the driver a written warning or even a termination notification. In each case, the system 200 may determine what data 250 is relevant and store 245 that data 250 for later use. In the case of certain received data 250, such as weather or GPS coordinates, the system 200 may not need to store 245 this data 250 or store 245 such in volatile memory, whereas the system 200 may determine that date, time, and equipment may be deemed, either by default or configured, more important and stored 245.

The system's 200 enabling logic 235 may predict accident based on a host of factors, which may include extracting or calculating the following data 250: the sensor's data, driving history, age of driver, sex of driver, health of the driver, percentage or total time on similar equipment, composition of the fleet (number of pickups vs. flatbeds vs. box trucks), weather conditions, weather forecasts, traffic congestion, the number of turns over a period of time or distance, frequency or amount of travel in accident prone areas, number of stop lights experienced over time, number of stop signs experienced over time, construction zones entered, usage of the systems or a similar system, amount of miles or driving time during rush-hour conditions, the driver's drug content, the driver's general health, frequency of right turns versus left turns, probability of right turns versus left turns, frequency of direction of travel, probability of direction of travel, frequency of direction of driving into the sun, and/or many other factors, including, for example, any factors disclosed elsewhere herein. The methods and systems 200 for predicting may be accomplished by enabling logic 235 that compares such received 220 data 250 to the least and most risky, known, driving behaviors, and then calculating a value. The system 200 may use this value to rank or rate a driver and his/her ability to safely operate a vehicle. The value may also be used to rate or rank a company in aggregate. The system 200, for example, may apply a base rate based on the age of the driver. Then, the system's 200 logic 235 applies a discount for a driver, who has been driving the same type of equipment for twenty years. Then, the system 200 may apply a debit for a driver, who frequently travels in highly congested areas. The system's calculated values may be used in hiring, training or termination events.

The received 220 data 250 may also be used by the system's 220 enabling logic to develop a scorecard for the fleet or the driver. The system 220 may create a scorecard to allow for quick examination of the operation at hand. In practice, the scorecard may be used by an underwriter or stakeholder to measure compliance with configurable parameters and their values. For example, a fleet may need to have a score of 90 to be considered safe, and, thereby, a good, insurable risk entitled to lower premiums than if the score were lower. If system's 200 scorecard, however, calculated a score of 80, then the fleet may not meet the insurer's required threshold of 90. In this particular case, the system 200 may configure the system's 200 parameters that the particular stakeholder finds relevant, and then the system may only apply those parameters before calculating a score. For instance, a client may want to know about average driver experience, travel time in heavy traffic conditions, and the time traveled in construction zones; the client may be unconcerned with other parameters, which the system's 200 enabling logic 235 would not include in determining the score for this client.

The system's 200 logic 235 may include reading, scanning, gathering, assessing, comparing, storing, culling, routing, reporting, uploading, or combinations thereof, by at least one device having an accident tracker app 215 installed or access to another device and/or resource(s) with the accident tracker app installed, the fleet management system 230 or combination thereof, of the data or the evidence 250 within an interval within a period. The interval and period may be six, seven, or eight times a day or any other interval within a period, either of which may be fixed, variable, set to default values, or configured by an authorized user, e.g., administrator, of the system 200. That data may be documents, files, data points, other information, and the fleet management system, the at least one device having an accident tracker app, or the combination thereof are in network connection and associated with logic, memory, processors, and data storage. Gathering, by the fleet management system, the at least one device having an accident tracker app, or the combination thereof, may occur of at least a portion of the data based on identified subject matter, wherein the identified subject matter comprises a person, entity, vehicle, location, event, words, or combinations thereof within a period, wherein, subsequent to gathering, at least a portion of the at least a portion of the data is routed based on the identified subject matter to a destination.

In additional, example embodiments, further enabling logic provides methods and systems 200 for generating a report in electronic or physical format, identifying the data to be stored as, searchable as, or for production in response to electronic logging device (“ELD”) or non-ELD formats or requirements, and purging, storing, transferring, or combination thereof, any portion of the data.

The fleet management system 230, which includes server(s) and resources 240, such as processor(s) 240 and enabling logic 235, accident tracker app 215, or combination thereof is able to determine, locally and/or remotely, what documents 250 must be stored 245, for how long, and present them to internal users of the system 200 and/or third parties as required. For example, the disclosed methods and systems 200 track the first document 250, received and/or generated by the system 200, of the day, the last document 250 of the day and six, seven, or eight (i.e., could be more or less than six, seven, or eight times daily based on the system's 200 set configurable parameters for collecting sensed/recorded/input data 250) documents 250 in between, based on configurable criteria being monitored by the system 200. For example, the system 200 may know, based on OCR, user input, location, GPS or other means what type of document 250 the system 200 received 220. If the processor 240 determines the data/document 250 is appropriate to keep the document for future presentation, the processor 240 may route it 250 to storage 245. If it 250 is not necessary for future presentation, then the system 200 may purge the document 250 or the system may be configured to store 245 all documents 250.

In another example embodiment, the system's 200 logic 235 may include scanning, gathering, assessing, comparing, storing, culling, routing, reporting, or combinations thereof, by the accident tracker app 215, the fleet management system 230 or combination thereof, of any documents 250 in the system 200, whether existing or to be generated by logic 235 in combination with the system's 200 resources 233, including non-depicted memory, and/or external resources, such as in external storage and/or memory, in an interval within a period as discussed in the preceding paragraph. Such documents 250 need have no relation to any accident, and may be related to one or more persons, such as a particular driver, a particular mechanic, a particular third-party service provider, and so forth. The fleet management system 230 is able to determine what documents 250 must be stored 245, for how long, and present them to internal users of the system 200 and/or third parties as required in line with examples presented in the preceding paragraph. If a processor 240 determines the document(s) 250 are appropriate to keep, then the processor 240 may route the documents 250 to one or more local or remote storage devices 245, whether internal 245 or external. If document(s) 250 are not necessary for future presentation or other purpose, then the system 200 may purge the one or more of the document(s) 250 or the system may be configured to store 245 all documents 250.

When a driver is required to, or chooses to, present documents 250 to a manager, administrator, factoring company, government official, peer or other entity or individual, the documents 250 may be shown on the user's display, and optionally sent 220 in any format supported by the system 200. These documents 250 are sorted and routed by enabling logic 235, reduced to hardware and/or software, in order to make the particular business operation using the disclosed methods and systems 200 more efficient, consistent and controlled.

Input and receipt 220 of the documents 250 may occur via cell phone camera, scanner, video recorder, software, email, fax, short-message-signal, input from another device, or otherwise. For example, the driver may use his cell phone or tablet camera to take a picture of a toll receipt or delivery ticket. In this case, the system 200 may determine that a toll receipt may not be a required document to retain but that the delivery receipt is. Accordingly, the delivery receipt, being data 250, may meet the requirements for one of the eight documents to be stored 245 for the day. The document 250 might also be uploaded via scanner to a provided web-application portal. In such a case, it 250 can be assigned to an operational unit such as a driver, worker, mechanic, truck, trailer, forklift, or other piece of equipment.

The processor(s) 240 and fleet management system 230, including its server(s) and other resources 233, may be configured to store 245 all documents 250 and present those on the web application, on a computer display, to a printer or some other audiovisual display. For example, the processor(s) 240 and fleet management system 230, including its server(s) and other resources 233, may determine if the document 250 needs an estimated or re-estimated time of arrival for billing, payroll, compliance, accounting or other purposes. If it 250 does not need, to be re-estimated, then such data 250 may not be needed for operational records. It might, however, need to be kept 245 for other reasons such as legal, HIPPA or employment reasons. In this case, the server and processor might route this to another area of storage 245 or to external storage in communication with the system 200.

Depending on the data 250 uploaded, the system's 200 logic 235 may be configured to automatically create a work order, prescription, referral, appointment, or reminder, by the accident tracker app 215 on the device 210, the fleet management system 230, or combination thereof, based on or for a third-party service provider, such as a mechanic, who is assigned to a truck that was in an accident. For example, if there is a fuel receipt 250 and the fuel mileage is significantly off from other similar vehicles, a work order may be created to change the filters, fluids and complete other preventive maintenance items. Accordingly, the system's 200 logic 235 may automatically or manually transceive, among the accident tracker app 215, the fleet management system 230, one or more third-party service providers, or combinations thereof, one or more work orders, at least a portion the evidence relevant to the one or more third-party service providers, bills, and/or combinations thereof.

During document 250 gathering for the worker, mechanic, driver, manager or other worker; the system's 200 enabling logic 235 may require input from the user indicating the type of document 250. The system 200 may also be configured to automatically determine which vehicle, cargo or piece of equipment to which the document 250 is applicable. For example, a driver may be assigned to a certain truck. That truck might be under dispatch to a certain customer. When the load is delivered, the customer signs for the cargo and this document 250 may be stored 245 in the driver's records 250 on his device 210 having the accident tracker app 215, but may also cause a record to be stored for the customer. The device 210 having the accident tracker app 215 may also automatically create other data 250, including, for example, invoice, send a text message, email, place a phone call, send a fax or otherwise confirm delivery, or geo-stamped undertaken activities so that such activities may be logged and tracked, such as for calculating mileage and fuel tax per jurisdiction at a later time, if requested, desired, or required. This confirmation may then be used to adjust inventory levels, begin the billing process, control other aspects of accounting, create training for the driver, update logistics programs, interface with factoring companies, among other things, all of which is data 250 that may be transmitted 220 to the system's 200 fleet management system 230 for optional storing 245, processing 240, and/or routing to third parties.

Moving on to additional disclosure, the disclosed methods and systems possess further enabling logic 235 for comparing the evidence. Such comparison may involve evaluating objective and/or subjective evidence, which may subsequently result in application of further logic 235 to assign fault for the accident to a driver, weather conditions, another driver, mechanical failure, health condition, and so forth. With the evidence in hard, yet further enabling logic 235 may predict the probability for re-occurrence of the accident based on a person in the accident, the type of the accident, the evidence, known variables, any other variables, or combinations thereof.

Subsequent to comparing the evidence and optionally assigning fault, enabling logic 235 associated with the device 210, its 210 accident tracker 215, fleet management system 230, or combinations thereof may determine a disposition for the accident. A disposition concerns what happens to and what to do with the people, property, and/or information involved in or impacted by the accident. For example, the disposition may involve determining a score for a driver, a driver's company, or both for an accident based on the evidence, wherein the evidence comprises weather conditions, mechanical fitness of type of fleet operated, time and day, traffic conditions, the severity of the accident, the driver's motor-vehicle records, the driver's history of accidents, the driver's service-hour-violation frequency, the driver's roadside-inspection-violation frequency, officer-mandated out-of-service frequency for the driver, the driver's familiarity with a kind of fleet operated, the driver's vital signs, the driver's drug content, the driver's general health, frequency of right turns versus left turns, probability of right turns versus left turns, frequency of direction of travel, probability of direction of travel, frequency of direction of driving into the sun, road conditions, the driver's driving behavior, data, measurements, known variables, deduced variables, calculated data or combinations thereof. By further example, a disposition may be an instruction as to where to go, how to go, and/or send people, property, and/or information involved in or impacted by the accident as stated here or elsewhere herein. In yet another example, a disposition may be a decision on degree of fault of each person and/or property involved in the accident.

Additional enabling logic associated with the device 210, its 210 accident tracker 215, fleet management system 230, or combinations thereof may locate, optionally based on communications with a global positioning system, at least one member from a group that includes a drug testing facility, hospital, mechanic's garage, tower, salvage yard, emergency responder's station, doctor's office, dentist's office, licensing office, gas station, insurance agency, service provider, insurance agency, or other agency, office, building, or facility. After such is found, then further enabling logic 235 may include selecting, whether digitally and/or vocally for instance, any or all of the members of the foregoing group based on cost, distance, location, price, preferred contractor, contractual terms, time, turnaround time, aptitude, reputation, recommendations, ratings, other parameters, or combinations thereof. The selection, itself, may be performed based on exemplary, foregoing criteria by the fleet management system 230, a person associated with or using the system 200, an external computer in network connection with at least a portion of the system 200 that is programmed to make such section, or otherwise. Furthermore, the logic 235 may include instructing, such as by transmitting a text message from the fleet management system 230 to the driver's device 210 having the loaded accidental tracker app 215, a person associated with the accident, e.g., a driver of a vehicle, to drive to, and/or communicate with a location that is a drug testing facility, hospital, mechanic's garage, tower, salvage yard, emergency responder's station, doctor's office, dentist's office, licensing office, licensing office, insurance agency, or other agency, office, building, or facility. That is, the instruction, which is a disposition as is any instruction provided by the disclosed methods and systems, may be: go to a drug testing facility, go to a hospital, go to a mechanic's garage, go to or call a tower, go to a salvage yard, go to an emergency responder's station, go to a doctor's office, go to a dentist's office, go to a licensing office, go to an insurance agency, go to an agency, office, building, facility, answer one or more questions, assess damage, attend a class, provide audiovisual information, acknowledge receipt of a disciplinary message, sign-off on the disciplinary message, take a test, unload or re-distribute cargo, travel by a different route to a destination, follow any other type of instructions, or combinations thereof. At such facility, hospital, garage, and so forth, the enabling logic 235 may include instructing a person associated with the accident to undertake an action, e.g., take a drug test, have a physical, etc. Furthermore, the instructions may be for re-routing, re-loading, unloading or combinations thereof to the device 210, 215, an agency, an office, a building, a facility, a shipper, a receiver, a mechanic, a broker or combinations thereof in network communication therewith 230. In addition to instructions, the fleet management system 230 may provide 220 data 250 to the device 210 having the loaded accident tracker app 215 with mapping directions, estimated times of arrival, or combination thereof to the device 210, 215, the fleet management system 230, an agency, an office, a building, a facility, a shipper, a receiver, a mechanic, a broker or combinations thereof in network communication therewith 230.

When the device 210 loaded with the accident tracker app 215 has received an instruction via network 220 or otherwise, enabling logic 235 may at least periodically detect (e.g., pinging) whether such device 210, 215 is within a predefined area associated with the instruction received by the device 210, 215. For instance, logic 235 may establish that the predefined area is a circle having a five-mile radius that includes the person and/or equipment item involved in the accident as well as the location to which a person associated with the device 210, 215 was instructed to go. More specifically, said person and/or equipment could be a driver of a company car, said person associated with the device 210, 215 could be the driver's company-issued cell phone 210 loaded with the accident tracker app 215, and the instruction could be for the driver to go to a selected garage for car repair, all of which is within the example five-mile radius. If such driver complies with the instruction, then the accident tracker app 215 could optionally message or otherwise communicate with the fleet management system 230 that driver went to the selected garage. The accident tracker app 215 may permit such messaging or otherwise communicating by any of a number of ways, including for example, automatically sending such to the fleet management system 230, prompting the driver on the company-issued cell phone 210 to confirm arrival to the fleet management system 230, leave it to the driver to confirm arrival to the fleet management system 230, or otherwise.

Further enabling logic 235 associated with at least the accident tracker app 215 may alert the fleet management system 230 if the device 210 loaded with the accident tracker app 215 is not within a configurably defined parameter that aligns with the instruction, i.e., with performance of the action associated with the instruction. Using the example in the preceding paragraph, if the driver with the device 210, 215 travels outside of the five-mile radius, then the device 210, 215 will send an alert to the fleet management system 230. This proximity-based alert system serves to provide notice that the driver may not be complying with the instruction(s) sent by the fleet management system 230. Accordingly, the fleet management system 230 may opt to send or call with the same or new instruction(s) to the device 210, 215, communicate by writing or voice with the driver for determining whether the driver intends to comply with the instructions, generate a report for filing and/or sending to the driver's management, emergency response officials, or otherwise. By such measures, the logic 235 permits the tracking, monitoring, and reporting of performance of instructions, i.e., whether the instructions are followed, when the instructions are followed by date and time-stamp, following-up through completion of the instructions required by the driver and each location, generating reports on the foregoing, and providing reports to management and other persons as is requested or necessary. To that end, the logic may require any portion of the system 200 to route to, communicate with, i.e., send and receive, or combination thereof, at least a portion the evidence, information, or a combination thereof, at least one member of a group that includes a drug testing facility, a hospital, a garage, a tower, an emergency responder's station, a doctor's office, a dentist's office, a licensing office, an insurance agency, or other agency, office, building, or facility, authority, governing body or combinations thereof. Through such communicating over the network 220 or otherwise, further enabling logic 235 permits the disclosed methods and systems 200 to process insurance or medical claims for the accident, as well as monitor and track performance of said process. Furthermore, additional logic 235 enables generating and optionally providing, by the fleet management system 230, reports to a hospital, a mechanic's garage, a tower, a salvage yard, an emergency responder's station, a doctor's office, a dentist's office, a licensing office, an insurance agency, an agency, office, building, facility, or combinations thereof.

Turning to another aspect, also disclosed are methods and systems for predicting a probability of an accident. As previously discussed, the methods and systems 200 may include identifying, based on evidence, a type of the accident, by a fleet management system 230 associated resources 233 including logic 235, processors 240, sensors and data storage 245. Further, the methods and systems 200 may also include gathering, by the fleet management system 230, the evidence related to the accident from one or more resources 233 in network communication 250 with the fleet management system 230 as previously discussed. Further still, the methods and systems 200 may include or may only include determining, by the fleet management system 230, the probability of the accident optionally based on the evidence comprising weather conditions, mechanical fitness of type of fleet operated, time and day, traffic conditions, traffic patterns, severity, cost, downtime, the type, associated person(s), driving records, driving score of any driver in the accident, data, measurements, road conditions, microclimates, probability of right turns versus left turns, probability of direction of travel, frequency of direction of driving into the sun known variables, deduced variables, calculated data or combinations thereof obtained from the one or more resources, sources, or combinations thereof in network communication, whereby the methods and systems 200 may base its prediction for the probability of the accident reoccurring. As part of this predicting, the methods and systems 200 may calculate the driving score of a driver in the accident. In addition, any of the foregoing step(s) or portions of the system 200 may be iterated over time in order to update the prediction, i.e., the probability of the accident, whereby probabilities may change over time if any evidence, for example, is time-dependent.

While the foregoing is directed to example embodiments of the disclosed invention, other and further embodiments of the invention may be devised without departing from the basic scope thereof, and the scope thereof is determined by the claims that follow.

What is claimed is:

1. A system for analyzing an accident, the system comprising:
an accident tracker app loaded on a device, a fleet management system, or combination thereof is in network communication and associated with logic, memory, processors, and data storage, wherein the accident tracker app, the fleet management system, or combination thereof are configured to:
identify, based on evidence, a type of the accident;
assess, based on the evidence related to the accident, severity of the accident;
compare the evidence for the accident; and
determine a disposition for the accident.

2. The system of claim 1, wherein to identify and assess the evidence comprises to read gauges, sensors, airbag deployment, instrumentation, vital signs, orientation, location, impact, velocity, speed, global positioning system data, orientation, location, impact forces and angles, g-force, acceleration, deceleration, temperature, user-input, other readable measurement or combinations thereof.

3. The system of claim 1, wherein to identify and assess the evidence comprises to receive data from a person, third party system, another device or combination thereof that is read, input or extracted, automatically or manually.

4. The system of claim 1, wherein to assess further comprises being configured to calculate any anticipated costs, downtime, or combinations thereof for the accident.

5. The system of claim 1, wherein the type comprises personal, bodily injury, property vehicular, boat-like, aviatorial, mechanical, chemical, electrical, hydraulic, pneumatic, other type, or combinations thereof.

6. The system of claim 1, wherein the device comprises a mobile phone, a smart phone, a personal digital assistant, a computer, a laptop, a tablet, watch, wearable device, implantable device, other device, or combinations thereof.

7. The system of claim 1, wherein the accident tracker app, the fleet management system, or combinations thereof comprises one or more platforms, wherein the logic optionally further comprises cross-platform logic.

8. The system of claim 1, wherein the processors comprise administrator processors, dispatcher processors, vehicle management processors, and accident tracker processors.

9. The system of claim 1, wherein the accident tracker app, the fleet management system, or combination thereof is further configured to gather the evidence from one or more sources in network connection therewith, wherein the evidence comprises data, measurements, known variables, deduced variables, calculated data or combinations thereof related to the accident.

10. The system of claim 1, wherein the accident tracker app, the fleet management system, or combination thereof is further configured to assign fault for the accident.

11. The system of claim 1, wherein to determine the disposition comprises determining a score of a driver associated with the accident based on the evidence, wherein the evidence comprises weather conditions, mechanical fitness of type of fleet operated, time and day, traffic conditions, the severity of the accident, the driver's motor-vehicle records, the driver's history of accidents, the driver's service-hour-violation frequency, the driver's roadside-inspection-violation frequency, officer-mandated out-of-service frequency for the driver, the driver's familiarity with a kind of fleet operated, the driver's vital signs, the driver's drug content, the driver's general health, frequency of right turns versus left turns, probability of right turns versus left turns, frequency of direction of travel, probability of direction of travel, frequency of direction of driving into the sun, road conditions, the driver's driving behavior, data, measurements, known variables, deduced variables, calculated data or combinations thereof.

12. The system of claim 1, wherein to determine the disposition comprises determining a score of a company associated with a driver of the accident based on the evidence, wherein the evidence comprises weather conditions, mechanical fitness of type of fleet operated, time and day, traffic conditions, the severity of the accident, the company's drivers' motor-vehicle records, the company's drivers' history of accidents, the company's drivers' service-hour-violation frequency, the company's drivers' roadside-inspection-violation frequency, officer-mandated out-of-service frequency for the company's drivers, the company's drivers' familiarity with a kind of fleet operated, the company's drivers' vital signs, the company's drivers' drug content, the company's drivers' general health, data, measurements, known variables, deduced variables, calculated data or combinations thereof.

13. The system of claim 1, wherein to determine the disposition comprises to determine a degree of fault for each person, property, or both involved in the accident.

14. The system of claim 1, wherein the accident tracker app, the fleet management system, or combination thereof is further configured to locate, optionally based on communications with a global positioning system, at least one member from a group comprising a drug testing facility, hospital, mechanic's garage, tower, salvage yard, emergency responder's station, doctor's office, dentist's office, licensing office, gas station, insurance agency, service provider, or other agency, office, building, or facility.

15. The system of claim 14, wherein the accident tracker app, the fleet management system, or combination thereof is further configured to select the at least one member in the group based on cost, distance, location, price, preferred contractor, contractual terms, time, turnaround time, aptitude, reputation, recommendations, ratings, other parameters, or combinations thereof.

16. The system of claim 14, wherein the accident tracker app, the fleet management system, or combination thereof is further configured to instruct a person associated with the accident to drive to, communicate with, undertake an action at, or combination thereof, a location associated with the at least one member.

17. The system of claim 16, wherein the accident tracker app, the fleet management system, or combination thereof is further configured to alert that the device is not within a configurably defined parameter aligning with performance of the action.

18. The system of claim 16, wherein to instruct comprises to instruct one or more members from a group comprising to: go to a drug testing facility, go to a hospital, go to a mechanic's garage, go to or call a tower, go to a salvage yard, go to an emergency responder's station, go to a doctor's office, go to a dentist's office, go to a licensing office, go to an insurance agency, go to an agency, office, building, facility, answer one or more questions, assess damage, attend a class, provide audiovisual information, acknowledge receipt of a disciplinary message, sign-off on the disciplinary message, take a test, unload or re-distribute cargo, travel by a different route to a destination, follow any other type of instructions, or combinations thereof.

19. The system of claim 18, wherein the accident tracker app, the fleet management system, or combination thereof is further configured to monitor and track performance of the instructions.

20. The system of claim 1, wherein the accident tracker app, the fleet management system, or combination thereof is further configured to route to, communicate with, or combination thereof, at least a portion of the evidence, information, or combination thereof, at least one member of a group comprising a drug testing facility, a hospital, a garage, a tower, an emergency responder's station, a doctor's office, a dentist's office, a licensing office, an insurance agency, or other agency, office, building, or facility, authority, governing body or combinations thereof.

21. The system of claim 20, wherein the accident tracker app, the fleet management system, or combination thereof is further configured to process insurance or medical claims for the accident for the at least one member of the group.

22. The system of claim 21, wherein the accident tracker app, the fleet management system, or combination thereof is further configured to monitor and track processing of the insurance or medical claims.

23. The system of claim 1, wherein the accident tracker app, the fleet management system, or combination thereof is further configured to provide mapping directions, estimated times of arrival, instructions for re-routing, re-loading, unloading or combinations thereof, or any combination thereof, to the device, the fleet management system, an agency, an office, a building, a facility, a shipper, a receiver, a mechanic, a broker, or combinations thereof in network communication therewith.

24. The system of claim 1, wherein the accident tracker app, the fleet management system, or combination thereof is further configured to generate and optionally provide reports to a hospital, a mechanic's garage, a tower, a salvage yard, an emergency responder's station, a doctor's office, a dentist's office, a licensing office, an insurance agency, an agency, office, building, facility, or combinations thereof.

25. The system of claim 1, wherein the accident tracker app, the fleet management system, or combination thereof is further configured to predict probability for re-occurrence of the accident based on a person in the accident, the type of the accident, the evidence, known variables, any other variables, or combinations thereof.

26. The system of claim 1, wherein the accident tracker app, the fleet management system, or combination thereof is further configured to cull the evidence.

27. The system of claim 1, wherein the accident tracker app, the fleet management system, or combination thereof is further configured to schedule, automatically or manually, an appointment with a third-party service provider.

28. The system of claim 1, wherein the accident tracker app, the fleet management system, or combination thereof is further configured to create, automatically or manually and based on or for a third-party service provider, a work order, prescription, referral, appointment, or reminder.

29. The system of claim 1, wherein the accident tracker app, the fleet management system, or combination thereof is further configured to scan, gather, assess, compare, store, cull, route, report, or combinations thereof, the evidence at an interval within a period.

30. The system of claim 29, wherein the interval within the period is six, seven, or eight times a day.

31. The system of claim 29, wherein the interval is fixed or variable and the period is fixed or variable.

32. The system of claim 29, wherein the interval, the period, or combination is defaulted or configurable.

33. The system of claim 1, wherein the at least a portion of the evidence to a third-party service provider in communication.

34. A system for predicting a probability of an accident, the system comprising:
an accident tracker app loaded on a device, a fleet management system, or combination thereof is in network communication and associated with logic, memory, processors, and data storage, wherein the accident tracker app, the fleet management system, or combination thereof are configured to:
identify, based on evidence, a type of the accident;
gather the evidence related to the accident from the one or more resources; and
determine, based on the evidence, the probability of the accident, wherein the evidence comprises weather conditions, mechanical fitness of type of fleet operated, time and day, traffic conditions, traffic patterns, severity, cost, downtime, the type, associated person(s), driving records, driving score of any driver in the accident, data, measurements, road conditions, microclimates, probability of right turns versus left turns, probability of direction of travel, frequency of direction of driving into the sun known variables, deduced variables, calculated data or combinations thereof.

35. The system of claim 34, wherein the accident tracker app, the fleet management system, or combination thereof is further configured to calculate the driving score.

36. The system of claim 34, wherein the accident tracker app, the fleet management system, or combination thereof is further configured to iterate any portions of the system to update the probability.

37. A system for processing data, the system comprising:
an accident tracker app loaded on a device, a fleet management system, or combination thereof is in network communication and associated with logic, memory, processors, and data storage, wherein the accident tracker app, the fleet management system, or combination thereof is configured to:
read data, wherein the data comprises documents, files, data points, or other information;
gather, based on identified subject matter, at least a portion of the data, wherein the identified subject matter comprises a person, entity, vehicle, location, event, words, or combinations thereof within a period; and
route at least a portion of the at least a portion of the data to a destination.

38. The system of claim 37, wherein the accident tracker app, the fleet management system, or combination thereof is further configured to upload the data.

39. The system of claim 37, wherein the interval within the period is six, seven or eight times a day.

40. The system of claim 37, wherein the interval is fixed or variable and time period is fixed or variable.

41. The system of claim 37, wherein the interval, the period, or combination is defaulted or configurable.

42. The system of claim 37, wherein the accident tracker app, the fleet management system, or combination thereof is further configured to generate a report in electronic or physical format.

43. The system of claim 37, wherein the accident tracker app, the fleet management system, or combination thereof is further configured to identify the data to be stored as, searchable as, or for production in response to electronic logging device (“ELD”) or non-ELD formats or requirements.

44. The system of claim 37, wherein the accident tracker app, the fleet management system, or combination thereof is further configured to purge, store, transfer, or combinations thereof, any portion of the data.

45. A method for analyzing an accident, the method comprising:
identifying, based on evidence, a type of the accident, wherein the identifying comprises by an accident tracker app loaded on a device and optionally a fleet management system, wherein the accident tracker app and the fleet management system are in network connection and associated with logic, memory, processors, and data storage;
assessing, by the accident tracker app, the fleet management system, or combination thereof, severity of the accident based on the evidence related to the accident;
comparing, by the accident tracker app, the fleet management system, or combination thereof, the evidence for the accident; and
determining, by the accident tracker app, the fleet management system, or combination thereof, a disposition for the accident.

46. A method for predicting a probability of an accident, the method comprising:
identifying, based on evidence, a type of the accident, by an accident tracker app, a fleet management system, or a combination thereof, associated with logic, processors, memory, sensors and data storage;
gathering, by the accident tracker app, the fleet management system, or combination thereof, the evidence related to the accident from one or more resources in network communication with the fleet management system; and
determining, by the accident tracker app, the fleet management system, or combination thereof, the probability of the accident based on the evidence comprising weather conditions, mechanical fitness of type of fleet operated, time and day, traffic conditions, traffic patterns, severity, cost, downtime, the type, associated person(s), driving records, driving score of any driver in the accident, data, measurements, road conditions, microclimates, probability of right turns versus left turns, probability of direction of travel, frequency of direction of driving into the sun known variables, deduced variables, calculated data or combinations thereof obtained from the one or more resources, sources, or combinations thereof in network communication.

47. A method for processing data, the method comprising:
reading, by a fleet management system, a device having an accident tracker app, or combination thereof, the data, wherein the data comprises documents, files, data points, other information, wherein the fleet management system, the at least one device having an accident tracker app, or the combination thereof, is in network connection and associated with logic, memory, processors, and data storage;
gathering, by the fleet management system, the device having an accident tracker app, or the combination thereof, at least a portion of the data based on identified subject matter, wherein the identified subject matter comprises a person, entity, vehicle, location, event, words, or combinations thereof within a period; and
routing, subsequent to the gathering, a least a portion of the at least a portion of the data to a destination.
